(19) United States
(12) Patent Application Publication
(10) Pub. No.: US 2024/0041126 A1
(43) Pub. Date: Feb. 8, 2024

(54) ELECTRONIC AEROSOL PROVISION SYSTEM

(71) Applicant: Nicoventures Trading Limited, LONDON (GB)

(72) Inventor: David Alan NELSON, London (GB)

(21) Appl. No.: 18/251,962

(22) PCT Filed: Nov. 2, 2021
(86) PCT No.: PCT/GB2021/052830

§ 371 Date: May 5, 2023

(30) Foreign Application Priority Data
Nov. 6, 2020 (GB) 2017558.4

(51) Int. Cl. A24F 40/51; A24F 40/42; A24F 40/57; A24F 40/53; G06K 7/10

(52) U.S. Cl. CPC A24F 40/51; A24F 40/42; A24F 40/57; A24F 40/53; G06K 7/10366

(57) ABSTRACT

Described is an aerosol provision system including a control body and a cartridge configured to engage with the control body, wherein the control body includes an aerosol generator configured to generate aerosol from aerosol-generating material, the aerosol provision system further including a aerosol-generating material storage area in the cartridge configured to hold a supply of aerosol-generating material to be aerosolized by the aerosol generator, circuitry configured to control a supply of energy from a power supply to the aerosol generator, and a safety element configured to actuate when the cartridge is engaged with the control body, wherein the circuitry is configured to prevent the supply of energy to the aerosol generator unless the safety element is actuated.

### PRIORITY CLAIM

The present application is a National Phase entry of PCT Application No. PCT/GB2021/052830, filed Nov. 2, 2021, which claims priority from GB Application No. 2017558.4, filed Nov. 6, 2020, each of which hereby fully incorporated herein by reference.

### FIELD

The present disclosure relates to vapor delivery non-combustible aerosol provision systems such as nicotine delivery systems (e.g. electronic cigarettes and the like).

### BACKGROUND

Aerosol provision devices such as e-cigarettes often contain a reservoir of an aerosol-generating material, typically including nicotine, from which an aerosol is generated, such as through vaporization or other means. An aerosol source for an aerosol provision system may comprise an aerosol generator (e.g. a heater) coupled to a portion of aerosol-generating material supplied from the reservoir. In many instances, the aerosol-generating material comprises a liquid which is transported from the reservoir to the aerosol generator via capillary wicking. When a user inhales on the device, the aerosol generator is activated to aerosolize a small amount of the aerosol-generating material, which is thus converted to an aerosol for inhalation by the user. In many instances, the reservoir and aerosol generator are comprised in a cartridge which can be detachably engaged with a control body which contains a power supply and control circuitry. When the cartridge is engaged with the control body, an electrical path is formed (e.g. via cooperating electrical contacts on cartridge and control body interfaces) enabling power from the power supply to be provided to the aerosol generator under the control of the control circuitry. If the cartridge and the control body are not engaged (e.g. electrical contacts on the cartridge and control body are not engaged with each other), an open circuit will exist between the power supply and the aerosol generator. This prevents the aerosol generator from being actuated unless the cartridge and control body are engaged.

However, providing the aerosol generator in particular in the cartridge can increase the amount of material wastage when the cartridge, which typically has a short lifetime than the control body, is replaced and/or disposed of. Indeed, non-refillable cartridges are generally replaced with a fresh cartridge when the liquid aerosol-generating material is depleted, typically resulting in the depleted cartridge being thrown away or recycled.

### SUMMARY

Various approaches are described which seek to help address some of these issues.

According to a first aspect of certain embodiments there is provided an aerosol provision system comprising a control body and a consumable configured to engage with the control body, wherein the control body comprises an aerosol generator configured to generate aerosol from aerosol-generating material, the aerosol provision system further comprising: an aerosol-generating material storage area comprised in the consumable and configured to hold a supply of aerosol-generating material to be aerosolized by the aerosol generator; circuitry configured to control a supply of energy from a power supply to the aerosol generator; and a safety element configured to actuate when the consumable is engaged with the control body, wherein the circuitry is configured to prevent the supply of energy to the aerosol generator unless the safety element is actuated.

According to a second aspect of certain embodiments there is provided a consumable for an aerosol provision system comprising the consumable and a control body configured to engage with the consumable, wherein the control body comprises an aerosol generator configured to generate aerosol from aerosol-generating material comprised in the consumable, circuitry configured to control a supply of energy from a power supply to the aerosol generator; and at least a part of a safety element, wherein the circuitry is configured to prevent the supply of energy to the aerosol generator unless the safety element is actuated, the consumable further comprising a aerosol-generating material storage area for holding a supply of aerosol-generating material to be aerosolized by the aerosol generator; and wherein; the consumable is configured the cause the safety element to actuate when the consumable is engaged with the control body.

According to a third aspect of certain embodiments there is provided a control body for an aerosol provision system comprising the control body and a consumable configured to engage with the control body, wherein the control body comprises an aerosol generator configured to generate aerosol from a supply of aerosol-generating material comprised in the consumable, circuitry configured to control a supply of energy from a power supply to the aerosol generator; and a safety element, wherein the circuitry is configured to prevent the supply of energy to the aerosol generator unless the safety element is actuated; wherein the control body is configured such that the safety element is actuated when the consumable is engaged with the control body.

According to a fourth aspect of certain embodiments there is provided circuitry for a control body for an aerosol provision system comprising the control body and a consumable configured to engage with the control body, wherein the control body comprises an aerosol generator configured to generate aerosol from a supply of aerosol-generating material comprised in the consumable, circuitry configured to control a supply of energy from a power supply to the aerosol generator; and a safety element, wherein the circuitry is configured to prevent the supply of energy to the aerosol generator unless the safety element is actuated; wherein the control body is configured such that the safety element is actuated when the consumable is engaged with the control body.

According to a fifth aspect of certain embodiments there is provided a method of operating an aerosol provision system comprising a control body and a consumable configured to engage with the control body, wherein the control body comprises an aerosol generator configured to generate aerosol from aerosol-generating material, the aerosol provision system further comprising: a aerosol-generating material storage area for holding a supply of aerosol-generating material to be aerosolized by the aerosol generator; circuitry configured to control a supply of energy from a power supply to the aerosol generator; and a safety element configured to actuate when the consumable is engaged with the control body, wherein the circuitry is configured to prevent the supply of energy to the aerosol generator unless the safety element is actuated.

According to a sixth aspect of certain embodiments there is provided an aerosol provision system comprising a control body and a consumable configured to engage with the control body, wherein the control body comprises aerosol generator means configured to generate aerosol from aerosol-generating material, the aerosol provision system further comprising: aerosol-generating material storage means comprised in the consumable and configured to hold a supply of aerosol-generating material to be aerosolized by the aerosol generator means; circuitry means configured to control a supply of energy from power supply means to the aerosol generator means; and safety means configured to actuate when the consumable is engaged with the control body, wherein the circuitry means is configured to prevent the supply of energy to the aerosol generator means unless the safety means is actuated.

According to a seventh aspect of certain embodiments there is provided a method of operating an aerosol provision system comprising a control body and a consumable configured to engage with the control body, wherein the control body comprises aerosol generator means configured to generate aerosol from aerosol-generating material, the aerosol provision system further comprising: aerosol-generating material storage means for holding a supply of aerosol-generating material to be aerosolized by the aerosol generator means; circuitry means configured to control a supply of energy from power supply means to the aerosol generator means; and safety means configured to actuate when the consumable is engaged with the control body, wherein the circuitry means is configured to prevent the supply of energy to the aerosol generator means unless the safety means is actuated.

It will be appreciated that features and aspects of the disclosure described above in relation to the first and other aspects of the invention are equally applicable to, and may be combined with, embodiments of the disclosure according to other aspects of the disclosure as appropriate, and not just in the specific combinations described above.

### BRIEF DESCRIPTION OF THE DRAWINGS

Various embodiments of the disclosure will now be described in detail by way of example only with reference to the following drawings:

FIGS. 1A to 1B schematically show an example aerosol provision system in accordance with examples of the present disclosure, the aerosol provision device comprising a consumable and a control body.

FIGS. 2A to 2B schematically show an example of an aerosol provision system in accordance with examples of the present disclosure, the aerosol provision system comprising a consumable and control body having a different arrangement than the aerosol provision system shown in FIGS. 1A and 1B.

FIGS. 3A to 3B schematically show an example of an aerosol provision system in accordance with examples of the present disclosure, the aerosol provision system comprising a consumable and control body having a different arrangement than the aerosol provision system shown in FIGS. 1A and 1B, and FIGS. 2A and 2B.

FIGS. 4A to 4B schematically show examples of a cartridge detection mechanism in accordance with some examples of the present disclosure.

FIGS. 5A to 5C schematically show examples of the position of a sensor element in a cartridge detection mechanism in accordance with some examples of the present disclosure.

FIGS. 6A and 6B schematically show examples of relevant distances in respect of engaging the cartridge with a control body in accordance with aspects of the present disclosure.

FIG. 7 schematically shows a circuit diagram including a sensor element with integrated switch acting as a safety element in accordance with aspects of the present disclosure.

FIG. 8 shows a graph depicting the sensor signal as a function of distance relative to an emitting element in accordance with aspects of the present disclosure.

FIG. 9 schematically shows a circuit diagram including a sensor element coupled to control circuitry with integrated switch acting as a safety element in accordance with aspects of the present disclosure.

FIG. 10 shows an example method for operating a safety element in accordance with aspects of the present disclosure.

FIGS. 11A and 11B schematically show further examples of a cartridge detection mechanism in accordance with some examples of the present disclosure in which the sensor element and emitter element are positioned in the control body.

FIGS. 12A and 12B schematically show further examples of a cartridge detection mechanism in accordance with some examples of the present disclosure.

FIGS. 13A and 13B schematically show further examples of a cartridge detection mechanism in accordance with some examples of the present disclosure, in which a reflective element is provided to reflect an emitted signal to a detector.

FIGS. 14A and 14B schematically show an example in which a sensor element and emitting element are configured to face one another across a recess comprising an interface portion of a control body, in accordance with some examples of the present disclosure.

FIG. 15 shows schematically a relationship between a detection state of the sensor element, and a distance indicating the degree of engagement of the cartridge and control body for systems in accordance with some examples of the present disclosure where attenuation of the emitted signal is determined.

FIGS. 16A and 16B schematically show an example in which a sensor element and emitting element are configured to face away from one another and detected reflections of emitted signal, in accordance with some examples of the present disclosure.

### DETAILED DESCRIPTION

The present disclosure relates to non-combustible aerosol provision systems that release compounds from an aerosol-generating material without combusting the aerosol-generating material. According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the provision system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Aerosol-generating material as used herein is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances (such as, but not limited to nicotine) and/or flavors, one or more aerosol-former materials (such as, but not limited to, glycerol) and optionally one or more other functional material(s) as desired.

Throughout the following description the term “e-cigarette” or “electronic cigarette” may sometimes be used, but it will be appreciated this term may be used interchangeably with vapor provision system/device, electronic vapor provision system/device, vapor delivery system/device, electronic vapor delivery system/device, aerosol provision system/device, electronic aerosol provision system/device, aerosol delivery system/device, and electronic aerosol delivery system/device. Furthermore, and as is common in the technical field, the terms “vapor” and “aerosol”, and related terms such as “vaporize”, “volatilize” and “aerosolize”, may generally be used interchangeably.

Typically, the non-combustible aerosol provision system may comprise a non-combustible aerosol provision device (sometimes referred to as a control part or control body) and a consumable for use with the non-combustible aerosol provision device.

In some embodiments, the disclosure relates to consumables comprising aerosol-generating material and configured to be used with non-combustible aerosol provision devices. These consumables are sometimes referred to as articles.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

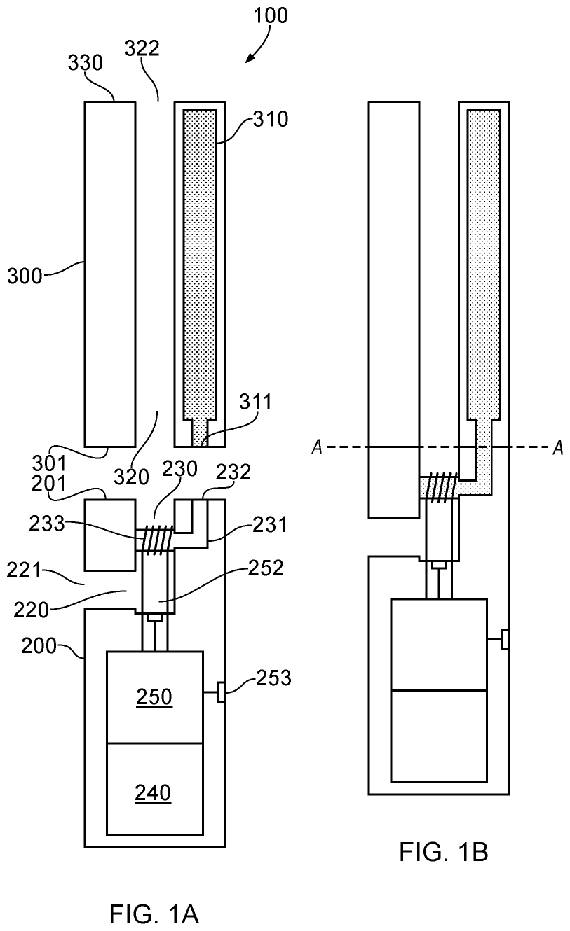

FIGS. 1A and 1B show schematic diagrams of an aerosol provision system 100 in accordance with some embodiments of the invention (not to scale). The aerosol provision system comprises two main components, namely a control body 200 and a detachable cartridge 300, each of which comprises further components as set out further herein. FIG. 1A shows the control body and cartridge in a disengaged condition, and FIG. 1B shows the control body and cartridge in an engaged condition, as described further herein.

The cartridge 300 is an example of a consumable. A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. In the examples described herein, the consumable is a cartridge. In the described embodiments, the cartridge 300 is configured to store a liquid aerosol-generating material, and subsequently the aerosol provision system is configured to generate aerosol from a liquid aerosol-generating material. The cartridge 300 may typically have a plastic housing or the like. However, it should be appreciated aerosol provision systems configured to operate with different types of consumables may also be realized in the accordance with the present disclosure.

The cartridge 300 comprises an internal reservoir 310 (or more generally an aerosol-generating material storage area) containing a supply of aerosol-generating material (shown via shading), from which an aerosol or vapor may be formed by one or more aerosol generators 230 associated with the control body 200. The reservoir 310 may comprise a hollow housing, a tank, a foam matrix, or any other structure suitable for retaining the aerosol-generating material. The aerosol-generating material may be a liquid, gel or solid aerosol-generating material, such as those described above, or combinations thereof. Accordingly, the aerosol-generating material storage area (or reservoir 310) is configured in a suitable manner to retain the aerosol-generating material as will be appreciated by the skilled person; for instance, the example reservoir 310 is suitable for retaining a liquid aerosol-generating material. The presence of aerosol-generating material in the reservoir 310 is indicated in FIGS. 1A and 1B by shading.

The cartridge may further include an air passage 320 which, when the cartridge is engaged with the control body 200, comprises a portion of a fluid communication pathway disposed between one or more air inlets 221, 321 and an air outlet 322. FIG. 1B shows the cartridge 300 engaged to the control body 200 at an interface shown by the hatched line AA, such that the air passage 320 comprised in the cartridge 300 is connected to an air passage 220 comprised in the control body, such that a fluid communication pathway is formed between air inlet(s) 221, 321 associated with the control body and/or cartridge and the air outlet 322 disposed at a mouthpiece 330 associated with the cartridge 300. As described further herein, an aerosol generator 230 is disposed within the fluid communication pathway formed by air passages 220 and 320, such that aerosol or vapor generated by the aerosol generator can be entrained into a flow of air passing from the air inlet(s) 221/321, through the fluid communication pathway, towards the mouthpiece 330 when the system is in use.

The control body 200 includes a power supply 240 to provide power to components of the aerosol provision system 100 and control circuitry 250 for generally controlling the functionality of the aerosol provision system 100. The power supply 240 may comprise a cell or battery, and may be rechargeable. In some embodiments, the aerosol provision system may alternatively or in addition receive electrical power from an external source (e.g. via a cable). The control body 200 further includes an aerosol generator 230 which is operable to receive a supply of energy from the power supply 240 and thereby generate a vapor or aerosol from a portion of aerosol-generating material originating from the reservoir 310 of the cartridge as described further herein. The aerosol generator is connected (directly or indirectly) to the control circuitry 250 and the power supply 240 by electrical connections comprising an electrical path between the power supply 240 and the aerosol generator 230. The control circuitry 250 is configured as set out further herein to control the supply of power from the power supply element 240 to the aerosol generator 230 in dependence on receiving an activation signal. The activation signal may be provided from an airflow sensor 252 and/or a button or other user input device 253 connected to the control circuitry and/or power supply. Broadly, the activation signal is a signal indicating the user's desire to activate the aerosol provision system for the purposes of generating aerosol for inhalation.

As set out further below, when the aerosol generator 230 receives power from the battery, as controlled by the control circuitry 250 in response to receiving an activation signal, energy is transmitted from the aerosol generator (e.g. a heater) to a portion of aerosol-generating material, causing a vapor or aerosol to be generated for inhalation by a user. The control circuitry 250 may comprise a microcontroller (e.g. an ASIC) including a CPU. The operations of the CPU and other electronic components of the aerosol provision system 100 are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required. The microcontroller can also comprise appropriate communications interfaces (and control software) for communicating as appropriate with other components in the control body 200 and/or cartridge 300, such as an activation sensor such as a puff sensor or other user input device, and other components described further herein such as an emitting element and a sensor used to determine the actuation of a safety element.

The control body 200 and cartridge 300 are configured to be connected together at an interface, such as the interface indicated by the line AA in FIG. 1B. Throughout the description, ‘engaging’ the control body 200 and cartridge 300 refers to the process of coupling the control body 200 and cartridge 300 to form an interface between them such that the control body 200 and cartridge 300 can function cooperatively to generate aerosol for inhalation by a user. Accordingly, engagement of the control body 200 and cartridge 300 may comprise forming/coupling of fluid communication paths and/or electrical communication paths between the control body 200 and cartridge 300 being to enable fluid (such as air or liquid aerosol-generating material) and/or electrical energy to pass across the interface between the control body and cartridge. To facilitate engagement of the control body 200 and cartridge 300, each of the control body 200 and cartridge 300 are configured with interface portions 201 and 301 respectively, which are arranged to interact with each other to facilitate forming of an appropriate interface. The configuration of the interface portions may follow any approach known to the skilled person. Thus, in some examples, a first interface portion comprises a recess (for instance a cylindrical or oval recess with an annular wall portion and a base portion), and a second interface portion comprises a boss shaped to be inserted into the recess via a sliding or clearance fit. In some examples, the boss comprises bayonet lugs, and the recess comprises cooperating L-shaped slots, such that the boss can be inserted fully into the recess and then rotated to prevent the cartridge and control body being separated along directions substantially aligned to a longitudinal axis of the device 100. In other embodiments, one of the recess and the boss comprises a magnetic portion, and the other comprises a magnetically attractable portion (comprising, for instance, a magnet of opposing polarity or a ferrous element), such that the cartridge can be held in place relative to the control body by magnetic attraction when the boss of the cartridge is inserted into the recess of the control body. In other examples, a first interface portion comprises a recess having a threaded inner surface, and a second interface portion comprises a boss with a corresponding thread on an outer surface, such that the cartridge can be affixed to the control body via a screw coupling. It will be appreciated in each of the foregoing examples involving a boss received within a recess, these may be distributed in any appropriate manner between the interface portions of the control body and cartridge. In some embodiments, the interface portion of a first one of the cartridge and control body is provided with a number of lugs or tabs formed on or extending from an external housing comprising the interface portion. Co-operating features, such as depressions or slots on the interface portion of the second one of the cartridge and control body may be provided such that when the control body and the cartridge are brought together at the interface, the features on the cartridge and the control body engage mechanically with one another to hold the cartridge 300 and the control body 200 in a fixed configuration relative to one another, providing a mechanically stable interface. It will be appreciated that these are only illustrative examples, and it will be appreciated that the interface portions can be configured to provide any kind of connection known in the art, such as snap fit, magnetic, push-fit, or screw connections.

Though FIGS. 1A and 1B schematically shown embodiments of an aerosol provision system 100 in which the cartridge is generally elongate and comprises an interface portion at an interface end which is distal from a mouthpiece end, this arrangement is merely an example, and many forms of interface between a cartridge and control body are possible, provided the interface is such that when the cartridge is engaged with the control body, the aerosol generator 230 is operable to generate an aerosol from a portion of aerosol-generating material within the cartridge. For instance, in some examples the cartridge 300 is configured to be partially or fully inserted within a recess in the control body 200.

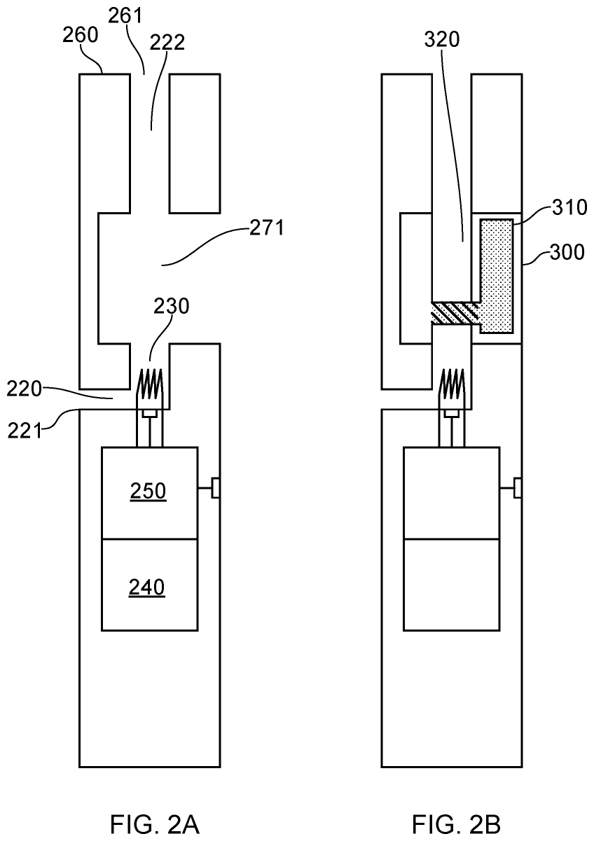

FIGS. 2A and 2B schematically show an example of an alternative arrangement of an aerosol provision system 100 to that shown in FIGS. 1A and 1B. FIG. 2A shows a control body which will be partially recognized from that of FIG. 1A. The control body comprises a power supply 240 and an aerosol generator 230. However in the embodiment shown schematically in FIG. 2A, the control body 200 also comprises a mouthpiece 260 comprising an air outlet 261, and a recess 271 into which a cartridge 300 can be inserted. A first air passage 220 communicates between the air inlet(s) 221 and the recess, and a second air passage 222 communicates between the recess 271 and the air outlet 261. A cartridge 300 is configured such that when the cartridge is engaged with the control body, (for instance, by inserting the cartridge partially or fully into the recess 271), aerosol-generating material from the reservoir 310 can be aerosolized by the aerosol generator 230 associated with the control body as set out further below. FIG. 2B shows control body 200 engaged with an exemplary cartridge 300. The cartridge comprises a reservoir 310 and an air passage 320. The external dimensions of the cartridge 300 and the internal dimensions of the recess 271 are configured such that the cartridge 300 can be inserted partially or fully into the recess in the control body. As set out above, the cartridge 300 may engage with the control body via a press-fit, magnetic or threaded connection, or any other method of engaging a cartridge to a control body known in the art. What is significant is that the cartridge engages the control body to form an interface causing air passage 320 to communicate with first air passage 220 and second air passage 222. In the example of FIG. 2B, the air passage 320 thereby comprises a portion of a continuous fluid communication path formed between the air inlet(s) 221 and the air outlet 261 when the cartridge and control body are engaged. As set out further herein, the cartridge is further configured such that aerosol-generating material from the reservoir 310 can be aerosolized by the aerosol generator 230 associated with the control body when the cartridge and control body are engaged.

The aerosolization of aerosol-generating material from the reservoir 310 comprised in the cartridge by the aerosol generator 230 associated with the control body can be achieved in a number of different ways, as set out further below. For example, as set out further herein, each of the cartridge and control body are configured with respective aerosol-generating material transfer component (sometimes referred to herein as a transport element), which cooperate when the cartridge and control body are engaged to allow aerosol-generating material to be transferred from the cartridge 300 to the aerosol generator 230 in the control body 200. An example of such a transfer element is a wick, formed of woven or unwoven cotton or glass filaments, and designed to form a path of fluid communication for liquid aerosol-generating material to cross the interface between control body and cartridge via capillary action, enabling aerosol-generating material to pass from the reservoir to a location where it can be aerosolized by the aerosol generator. However, the skilled person will appreciate that other transfer elements may be used for different types of aerosol-generating material, for example a pump or a pushrod, etc.

FIGS. 1A and 1B schematically show such an arrangement detailed below. The aerosol generator 230 is arranged in the vicinity of an outlet end of an aerosol-generating material transport element 231 which is configured to facilitate the transport of aerosol-generating material towards the aerosol generator 230. An interface end 232 of the transport element is configured to couple with a reservoir outlet 311, disposed on an external surface of the cartridge 300, when the cartridge is engaged with the control body. This coupling forms a path of fluid communication between the reservoir 310 in the cartridge and the outlet end of the transport element 231. The reservoir outlet 311 of the cartridge can comprise an aperture in the reservoir or a conduit connected to the reservoir, arranged to open onto the interface portion of the cartridge. The outlet end of the transport element 231 is arranged to provide aerosol-generating material present within the transport element for aerosolization by the aerosol generator 230. Thus, in some examples, a portion of the outlet end of the transport element comprises a porous element 233 (e.g. a wick) in fluid communication with the rest of the transport element 231. In some examples, the porous element comprises, for instance, a cotton material, a ceramic material, a mesh material, a woven, or non-woven material. In some instances a substantial portion or all of the transport element 231 comprises a porous material formed, for instance, from the same material as the porous element 233. The transport element 231 may optionally comprise a pumping element disposed along its length to facilitate the transport of precursor from the reservoir 310 to the porous element 233 when the cartridge and control body are engaged. FIG. 1B schematically shown a scenario whereby engagement of the control body and cartridge has coupled the transport element 231 in the control body to the reservoir 310 of the cartridge, enabling aerosol-generating material (indicated by the shaded region) to pass into the control body to a porous element 233 (e.g. a wick) in the vicinity of the aerosol generator 230.

The aerosol generator 230 may comprise any suitable component which is operable to generate an aerosol from a supply of aerosol-generating material. In some implementations, the aerosol generator is a heater (or heating element) configured to subject the aerosol-generating material to heat energy, so as to release one or more volatiles from the aerosol-generating material to form an aerosol. In some implementations, the aerosol generator is configured to cause an aerosol to be generated from the aerosol-generating material without heating. For example, the aerosol generator may be configured to subject the aerosol-generating material to one or more of vibration, increased pressure, or electrostatic energy. In examples where the aerosol generator comprises a heater, the heater is configured to be heated by supplying a current from the cell or battery. For example, the heating element may comprises a coil of resistive heating material in contact with which (e.g. within the coils of which) is disposed a portion of porous element 233. In other examples, the heating element may comprise a film, trace or coating of heatable material disposed upon or within a portion of porous element 233. In some instances the heating element comprises a resistance heating material, such as nichrome, and the heating element is heated by passing a current through the material. In some instances, the heater element comprises a susceptor configured to be heated when in the presence of a magnetic field generated by a drive coil. In some instances the aerosol generator comprises a piezo-electric element, and the outlet end of the transport element 231 is configured to provide aerosol-generating material to the piezoelectric element for aerosolization.

The aerosol generator may be disposed within an air passage 220 such that aerosol generated by the aerosol generator can be entrained into a flow of air in the air passage. Porous element 233 may be disposed within the air passage in the vicinity of the aerosol generator, for example, in the manner of a cantilever or bridge fully or partially traversing the air passage 220. It will be appreciated that the preceding description of aerosol-generating material transport arrangements can be applied in respect of a cartridge and control body configured as shown in FIGS. 2A and 2B (e.g. a cartridge comprising a pod which is inserted into a recess within a control body).

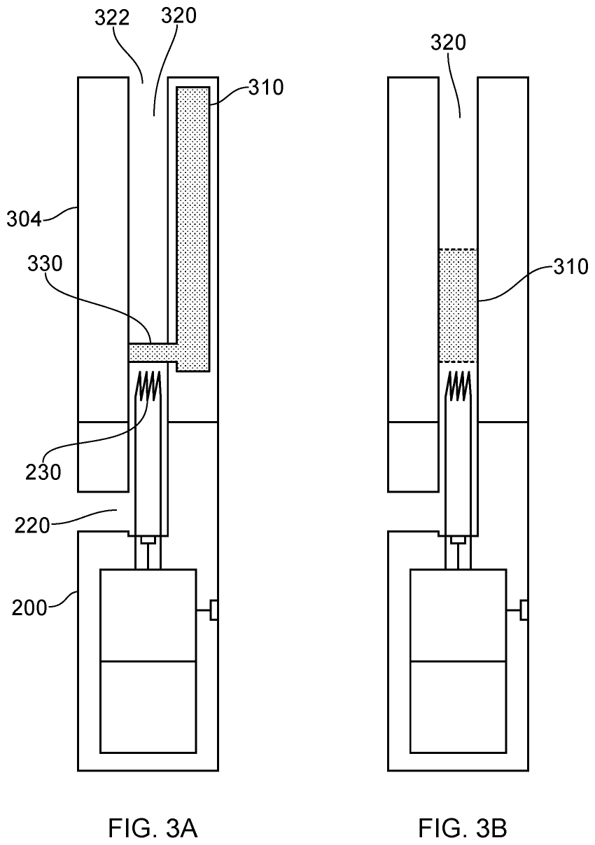

In other embodiments, the cartridge and control body may be configured such that aerosol precursor is not transported across the interface between the cartridge and control body when the cartridge and control body are engaged together. In such arrangements, the aerosol generator 230 is configured such that when the control body 200 and the cartridge 300 are engaged, aerosol can generated by the aerosol generator 230 from a portion of aerosol-generating material which is retained within the cartridge 300. This can be achieved in a number of different ways. For instance, in some embodiments, the aerosol generator is configured such that when the control body is engaged with the cartridge, the aerosol generator is brought into contact with or close proximity to a portion of aerosol-generating material retained within the cartridge. An example of this arrangement is show schematically in FIGS. 3A and 3B. FIG. 3A will be recognized from FIG. 1B, and shows a control body 200 engaged with a cartridge 300. However, unlike the arrangement shown in FIG. 1B, the cartridge 300 comprises a transport element 330 communicating between the reservoir and the air passage 320 within the cartridge. The transport element 330 may be configured in a similar manner to the transport element 231 described further herein (e.g. in terms of materials), with the difference that transport element 330 communicates directly between the reservoir and the air passage 320 within the cartridge 300, without providing a path of fluid communication for aerosol-generating material from the cartridge 300 to pass into the control body 200. In some examples, the cartridge 300 does not comprise a liquid transport element, but rather comprises a supply of aerosol-generating material disposed within the air passage of the cartridge. In such instances, it may be considered that the reservoir 310 of aerosol-generating material is situated partially or fully within the air passage. Thus according to some embodiments, the aerosol-generating material comprises a solid material, such as a plant-based material (e.g. tobacco), and the reservoir comprises a portion of aerosol-generating material disposed within the air passage. The portion may in some instances comprise a plug of solid material. Alternatively or in addition, a portion of the air passage may be filled with solid material (for instance, comprising plant material such as tobacco). The solid material may be held between upstream and downstream meshes disposed across the air passage to hold the solid material in place within the cartridge. FIG. 3B shows schematically an example of such a configuration, whereby a reservoir 310 of aerosol-generating material comprising shredded plant material is disposed in air passage 320. The cartridge may in some instances comprise a wrap of paper or other film-type material, rolled into a tube, and containing plant based aerosol-generating material such as tobacco.

In embodiments where aerosol-generating material from the reservoir in the cartridge is not configured to be transported to the control body for aerosolization (e.g. the aerosol-generating material remains within the cartridge), the aerosol-generating material may be aerosolized by the aerosol generator 230 in a number of ways. In some embodiments, the aerosol generator may be arranged such that when the control body and the cartridge are engaged, the aerosol generator 230 is inserted into, abuts, surrounds, or is near to a portion of aerosol-generating material comprised in the cartridge, for example, held in a porous element 233, or comprised in a reservoir 310 disposed within air passage 320. FIG. 3A schematically shows an example in which the aerosol generator (e.g. a heater) associated with the control body 200 is brought into the vicinity of (e.g. near, against or into) a porous transport element 330 containing aerosol-generating material in the form of a liquid or gel. FIG. 3B schematically shows an example in which the aerosol generator is brought into the vicinity of (e.g. near, surrounding, abutting, or inserted into) a reservoir 310 of solid aerosol-generating material disposed within the air passage 320. The aerosol generator may need to be configured such that it can be brought into proximity to the aerosol-generating material in the cartridge when the cartridge and control body are engaged. For example, as shown schematically in FIGS. 3A and 3B, the aerosol generator 230 protrudes from the housing of the control body 200 in such a way that when the control body 200 and cartridge 300 are engaged, the aerosol generator 230 is received into air passage 320.

In some embodiments, the aerosol generator 230 is arranged such that it directly aerosolizes the aerosol-generating material, for example, by heating or by piezoelectric aerosolization. In embodiments where the aerosol generator 230 comprises a heater, the heat may be directly conducted from the heater into the aerosol-generating material, or transferred across an air gap to radiatively heat the aerosol-generating material. In other instances the aerosol generator 230 comprises a heater located at a position in the fluid communication path upstream of a portion of aerosol-generating material disposed in the air passage 320 of the cartridge (e.g. liquid or gel held in a porous element 331, or a portion of solid material). To generate aerosol, the heater heats air in either passage 220 within the control body or 320 within the cartridge, which passes downstream to the aerosol-generating material in the cartridge under the influence of suction at an air outlet 322 or 261, and the heated air causes the aerosol-generating material to be aerosolized. Alternatively or in addition, the aerosol generator 230 may generate an aerosol or vapor at a location upstream of the aerosol-generating material within the cartridge.

It will be appreciated that any of the foregoing descriptions of respective arrangements of aerosol-generating material and aerosol generator can be applied to different control bodies and cartridges, for example cartridges designed to be engaged with a distal portion of a control body, or cartridges designed to be received fully or partially into a recess in a control body.

It has been recognized there may some issues arising in aerosol provision systems such as those described in the foregoing description, wherein an aerosol generator is associated with a control body containing a power supply, rather than with a cartridge (e.g. a ‘cartomizer’) configured to be engaged to the control body for use. In many aerosol provision systems, the aerosol generator is comprised in the cartridge, and electrical contacts are disposed at respective interface portions of the cartridge and control body, forming an electrical path between the aerosol generator 230 and the power supply 240 when engagement of the cartridge and control body brings the contacts into abutment. Thus if the cartridge and control body are not engaged, an open circuit condition exists in the circuit supplying power to the aerosol generator 230, and the aerosol generator 230 is thereby automatically prevented from being supplied with power unless the cartridge 300 and control body 200 are engaged.

However, in systems such as those described herein, wherein the aerosol generator 230 and power supply 240 are both associated with the control body 200, there is a potential for the aerosol generator 230 to be actuated when the cartridge 300 is not engaged with the control body 200. This may lead to depletion of the power supply 240, if the control circuitry 250 receives an activation signal and supplies power to the aerosol generator 230 whilst the control body and cartridge are disengaged. When the aerosol generator 230 comprises a heater, such accidental activation may result in a fire or burn risk, particularly if the configuration of the control body 200 is such that the heater is exposed when the control body and the cartridge are disengaged.

Thus, according to embodiments of the disclosure, the aerosol provision system 100 is provided with a safety element, and the aerosol provision system 100 is configured such that energy cannot be supplied from the power supply 240 to the aerosol generator 230 unless the safety element is actuated. The safety element is configured such that it can be in an actuated state only when the cartridge is engaged with the control body. Circuitry controlling a supply of energy from a power supply to the aerosol generator is configured to prevent the supply of energy to the aerosol generator unless the safety element is actuated. According to embodiments of the disclosure, a sensor element is associated with a first one of the control body and the cartridge of the aerosol provision system. The sensor element is configured such that its detection state varies in dependence on a characteristic associated with the second one of the cartridge and the control body in such a way that the presence of the second one of the cartridge and control body when the cartridge is engaged with the control body influences the detection state of the sensor element, and wherein an actuation state of the safety element depends on the detection state of the sensor element. Accordingly a detection state when the cartridge is engaged with the control body is different to a detection state when the cartridge is not engaged with the control body.

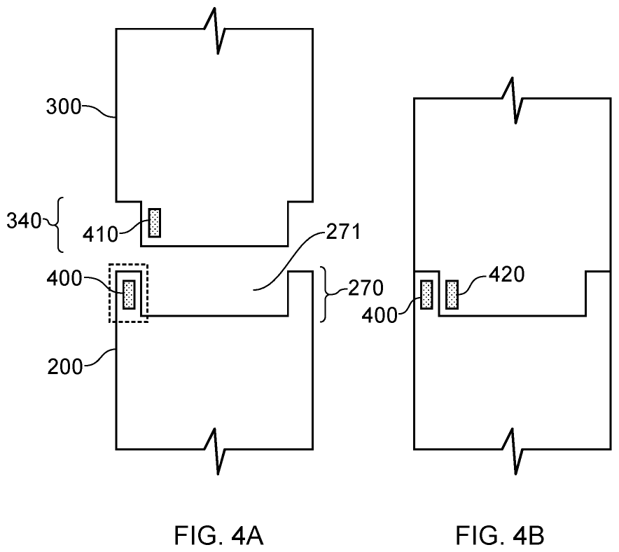

FIGS. 4A and 4B schematically shows a first embodiment of the present disclosure. According to this embodiment, a sensor element 400 is disposed in or on the control body 200, being configured such that its detection state varies in dependence on a characteristic of a signal or field emitted by an emitting element 410 associated with the cartridge 300 and control body 200. Although FIGS. 4A and 4B show an implementation where the sensor element 400 is disposed in the control body 400 and the emitting element 410 is in the cartridge 300, it should be appreciated that the sensor element 400 may instead be located in the cartridge 300 and the emitting element 410 disposed in the control body 200.

FIG. 4A shows the sensor element 400 associated with an interface portion 270 of the control body 200, which in this example comprises a recess 271 formed in an end of the control body 200. FIG. 4A further shows an emitting element 410 associated with an interface portion 340 of the cartridge 300, which is in this example comprises a boss shaped to be received into the recess 271. FIG. 4A schematically shows a scenario in which the control body and the cartridge are not fully engaged, whereas FIG. 4B schematically shows a scenario in which the control body 200 and the cartridge 300 are fully engaged, and in which the emitting element 410 and sensor element 400 have been brought into closer proximity with one another. As set out further herein, the properties of the sensor element 400 and emitting element 410, and their spatial arrangement with respect to the first and second ones of the cartridge 300 and the control body 200, are configured such that the sensor element 400 has a first detection state (or range of possible detection states) when the cartridge 300 and control body 200 are engaged, which is different from a detection state (or range of possible detection states) when the cartridge 300 and control body 200 are not engaged. Thus a change in detection state of the sensor element 400 as the cartridge 300 and control body 200 are engaged and disengaged is indicative of a change in the proximity and/or orientation of the emitting element 410 relative to the sensor element 400 brought about by a change in the intensity and/or orientation at the sensor element location of the field or signal emitted by the emitting element 410. Accordingly the detection state of the sensor element 400 can provide an indication of whether or not the control body 200 and cartridge 300 are fully engaged, and/or the degree of engagement of the control body 200 and cartridge 300.

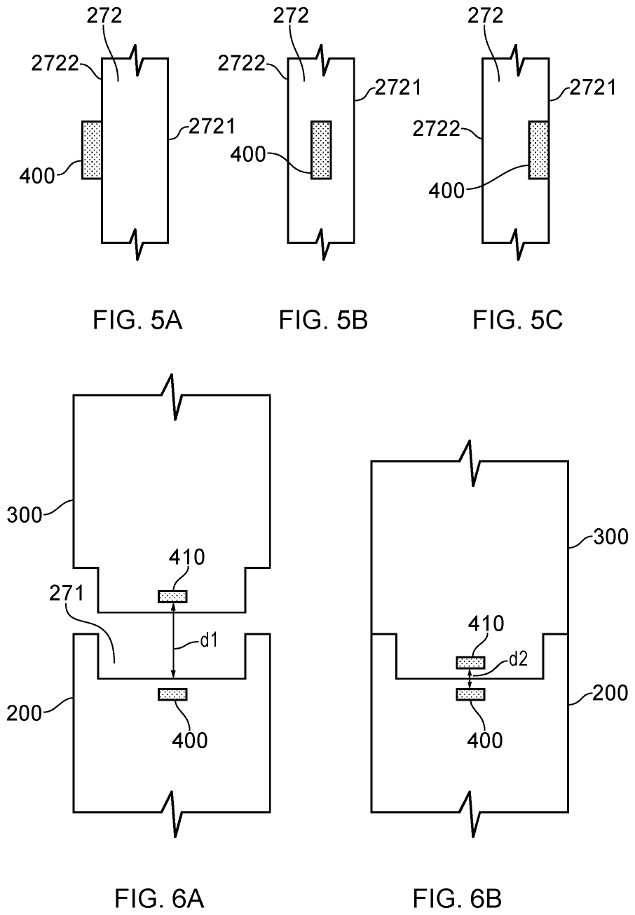

The sensor element 400 will generally be disposed in the vicinity of the interface portion 270 of the first one of the cartridge 300 and the control body 200, for instance, disposed on, embedded in, or disposed internally to a portion of a housing of the first one of the cartridge 300 and the control body 200 comprising the interface portion 271. FIG. 5A is a schematic cross-section through a portion of a housing comprising the interface portion 270 of the control body 200, for example a cross section along the longitudinal axis of the aerosol provision system 100 through a portion of an annular wall 272 which defines part of the inner surface of the recess 271 shown schematically in FIG. 4A. Accordingly, an outer surface 2721 of the annular wall 272 faces into the recess 271, and an outer surface 2722 of the annular wall 272 faces into an internal space of the first one of the cartridge 300 and the control body 200. Alternatively, outer surface 2722 may comprise an external surface of the first one of the cartridge 300 and the control body 200. In FIG. 5A, the sensor element 400 is shown disposed on the outer surface 2722 of the wall 272 (e.g. fixed through adhesion or mechanical fastening, or partially embedded into the inner surface). FIG. 5B will be recognized from FIG. 5A, but shows the sensor element 400 embedded between the two outer surfaces 2721 and 2722 of the wall 272. FIG. 5C will be recognized from FIGS. 5A and 5B, but shows the sensor element 400 disposed external or partially external to the outer surface 2722 of the wall facing the recess 271 (e.g. fixed through adhesion or mechanical fastening, or partially embedded into the inner surface). The sensor element 400 may be disposed so as to lie flush with the outer surface of the wall, or recessed from the wall surface, for example, within a depression or channel. It will be appreciated that the sensor placements relative to a housing structure shown in FIGS. 5A, 5B and 5C may equally be applied in respect of other locations of the sensor element with respect to the interface portion of the first one of the cartridge and control body, for instance disposed in, on, or internal to the base of a recess such as the recess shown schematically in FIG. 4A. Alternatively the interface portion 270 may not comprise a recess, and the wall 272 comprises a portion of an outer housing of the first one of the cartridge 300 and the control body 200. In some examples, the sensor element is comprised in a portion of the first one of the cartridge and control body away from the interface portion. It will be appreciated that the sensor element 400 may be associated with either the control body 200 or the cartridge 300.

In a similar manner, the emitting element 410 may be disposed on, in, or internal to a portion of a housing comprising the interface portion of the second one of the cartridge and the control body, being located relative to a portion of a housing comprising a part of the second one of the cartridge 300 and the control body 200 in the same manner as shown for the sensor element arrangements in FIGS. 5A, 5B and 5C. However, it will however be appreciated these configurations are examples only, and the respective arrangements of the sensor element 400 and emitting element 410 in or on the first and second ones of the cartridge 300 and control body 200 can take different forms depending on the nature of the interface between the cartridge 300 and the control body 200, the nature of the field or signal emitted by the emitting element 410, and the construction of the cartridge and control body (for example, the shapes and dimensions of housing components, and the materials from which they are made).

Generally, the position of the emitting element 410 will be selected such that the distance d between the emitting element 410 and the sensor element 400 is minimized when the cartridge 300 is fully engaged with the control body 200. For example, FIG. 6A shows schematically an emitting element 410 embedded in the basal surface of a boss comprising an interface portion of a second one of a cartridge 300 and control body 200, and a sensor element 400 embedded in the basal surface of a recess 271 of a first one of the cartridge and control body into which the boss is received to engage the cartridge 300 and the control body 200. In FIG. 6A the cartridge 300 and control body 200 are not fully engaged, and the distance d between the emitting element and the sensor element is indicated by d1. FIG. 6B, the cartridge 300 and control body 200 have been fully engaged, such that the basal surface of the boss contacts the basal surface of the recess. The distance between the sensor element 400 and emitting element 410 is thus minimized, taking a value d2, which is smaller than the distance d1. It will be appreciated the emitting element 410 and sensor element 400 can be disposed at any location on the control body 200 and cartridge 300 provided that the signal or field emitted by the emitting element 410 can act to influence the detection state of the sensor element 400, such that when the cartridge 300 is fully engaged with the control body 200, the detection state of the sensor is different to that when the cartridge 300 is not fully engaged with the control body 200. For instance, if the signal or field emitted by the emitting element 410 comprises a magnetic field, it may not be necessary for the emitting element 410 and sensor element 400 to be associated with the interface portions of the cartridge and the control body, provided the field strength is sufficiently large and the sensor element 400 sufficiently sensitive that the detection state of the sensor element 400 when the cartridge 300 and control body 200 are engaged is different to the detection state of the sensor element 400 when they are not engaged.

The sensor element is configured to have a detection state which varies in dependence on (e.g. is sensitive to) one or more characteristics of a field or signal emitted by the emitting element. The emitting element and the sensor element are thus matched such that the sensor element exhibits a sensitivity of its detection state to the particular kind of signal or field emitted by the emitting element. The sensor element can be configured such that the detection state varies in dependence on any suitable characteristic of an incident field or signal, such as, for instance, its intensity, directionality, periodicity, or any other characteristic. As one non-limiting example of a detection state, the sensor element may comprise a magnetic sensor such as a magnetoresistive sensor or a reed switch, the detection state of which can comprise the resistance across two or more terminals of the sensor element, said resistance being configured to vary as a function of the orientation and/or intensity of an incident magnetic field. However, as described further herein, it will be appreciated the detection state of the sensor element can associated with any physical property which varies in dependence on a characteristic of an incident field or signal, such as, for example, a resistance, inductance, capacitance, reactance, impedance, or reluctance property.

It will therefore be appreciated that a large range of sensor types may be used as the sensor element, provided the sensor element can be paired with an emitting element which emits a signal or field to which the detection state of the selected sensor exhibits sensitivity.

For example, in some embodiments, the sensor element comprises a magnetic sensor such as a reed switch or magnetoresistive sensor, and the emitting element comprises a magnetic field generating element such as a magnet, for instance, a rare earth magnet comprising a neodymium or samarium-cobalt magnet. The use of a magnet as the emitting element 410 may be suitable when positioned in the cartridge in particular as no power supply (or electrical connection to the control body 200) is required, thus simplifying the design of the system as a whole. That is not to say, however, that the magnet as an emitting element 410 cannot be located in the control body 200 with the e.g., reed switch as the sensor element 400 disposed in the cartridge 300, but in such implementations at least signal lines or a wireless communication mechanism for communicating the detection state of the sensor element 400 to the control body 200 may be present in the cartridge in such an implementation. A magnet used to provide such a field may also perform a function of coupling the cartridge to the control body when the control body and cartridge are engaged, as described further herein. The sensor element itself may be configured to be attracted to the magnetic field so as to enable the cartridge and control body to be coupled into the engaged state by magnetic attraction.

In other embodiments, the sensor element comprises a light-sensitive element such as a photodiode, and the emitting element comprises a light source such as an LED element or laser, with associated driver circuitry. More generally, the sensor element could comprise any sensor configured with a detection state which varies in dependence on incident electromagnetic radiation, and the emitting element could be any suitable source of electromagnetic radiation to which the sensor element is sensitive (for instance, a radio signal).

The emitting element may in other instances provide an acoustical signal as the cartridge and the control body are engaged. For instance the interface portions of the cartridge and/or the control body may be configured with features which interact mechanically to provide an acoustical signal (such as a ‘click’) when the cartridge and control body are brought into engagement, and the sensor element can comprise an acoustical sensor configured such that the detection state of the sensor element is sensitive to the acoustical signal.

Depending on the nature of the field or signal emitted by the emitting element, a portion of the housing comprising each of the control body and the cartridge (e.g. the respective interface portions) may be shaped and/or made of suitable material (e.g. a material partially or fully transparent to the field or signal) such that the field or signal can be emitted from the emitting element and received by the sensor without being unduly attenuated or distorted. Thus the properties of any portions of the control body and the cartridge lying in the path between the sensor and the emitting element when the control body and cartridge are engaged may need to be chosen so as to permit the coupling of the signal or field between the emitting element and the sensor. For instance a light source may be embedded in or disposed internal to a wall of a housing of the second one of the cartridge and the control body, and a photo-sensor may be embedded in or disposed internal to a wall of a housing of the first one of the cartridge and control body, and portions of either housing in the vicinity of a transmission path between the light source and the sensor when the cartridge and control body are engaged may be provided with an aperture, or be formed of a transparent or translucent material to allow light to pass from the light emitting element to the sensor when the cartridge and control body are engaged. If the emitting element is a magnetic field emitting element and the sensor a magnetic sensor, the materials used to fabricate the cartridge and control body may be selected so as not to unduly attenuate or distort the magnetic field emitted by the emitting element. This may comprise the use of predominantly non-ferrous materials in the vicinity of the sensor element and emitting element.

As described above, the aerosol provision system of the present disclosure comprises a safety element which is configured to permit or prevent power being supplied to the aerosol generator 230. The safety element is arranged to be actuated, which in this regard, means a change in state (either electrical or physical), wherein an actuation state of the safety element depends on the detection state of the sensor element. Broadly speaking, the safety element may comprise the sensor element 400 and switch such that the combination of these components provide the safety element.

In some examples of the present disclosure, the safety element comprises a switch. Actuation of the safety element comprises the switch being closed to provide a closed circuit via which current can flow from the power supply through the switch. The switch is therefore configured such that the switch state (i.e. open or closed) of the switch varies in dependence on the detection state of the sensor element 400. Thus, detection states induced by a predefined range of intensity and/or directionality of incident field or signal will correspond to a closed switch position in which current can flow through the switch. Detection states where such a field or signal is not present will correspond to an open switch position in which current cannot flow through the switch.

In some examples the switch 402 comprises a reed switch or other magnetic switch, configured with a detection state which depends on the properties of an incident magnetic field provided by an emitting element 410 comprising a magnet. In some detection states (e.g. those induced by a suitably strong magnetic field with a suitable orientation) the switch state will be a closed state such that current can flow from the power supply through the switch and, e.g., to the aerosol generator. This closed state corresponds to an actuated state of the safety element. In other detection states (e.g. in the absence of a suitably strong magnetic field with a suitable orientation) the switch state will be open such that current cannot flow through the switch and, e.g., to the aerosol generator, even if an activation signal is provided by an airflow sensor or other user input. This open state corresponds to a non-actuated state of the safety element.

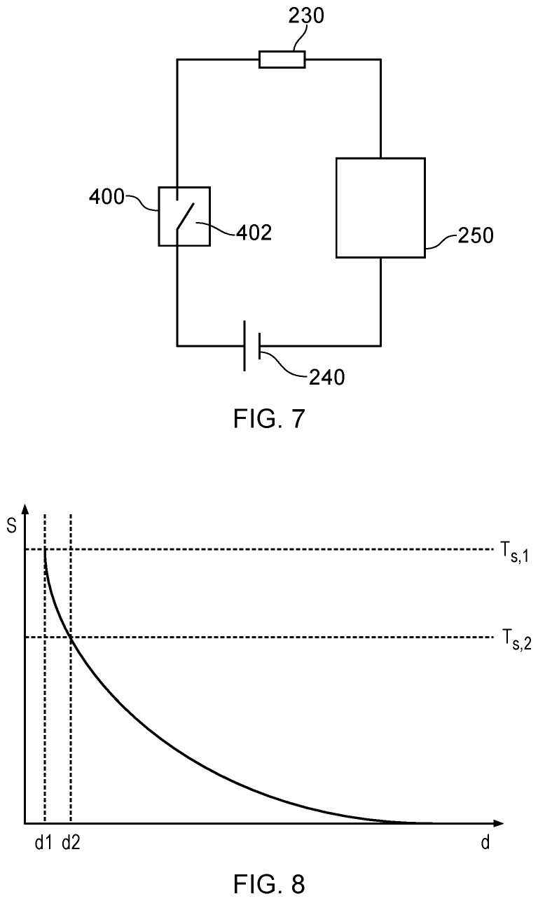

FIG. 7 shows a schematic example of a circuit in which the sensor element 400 comprises, or otherwise is, the switch 402. That is, the sensor element 400 and switch 402 are one and the same component. The combined sensor element 400 and switch 402 act as the safety element in this implementation. The sensor element 400 (such as that shown in FIGS. 6A and 6B) and switch 402 are wired in series with the power supply 240 comprising a battery, an aerosol generator 230, and control circuitry 250. Control circuitry 250 comprises at least one further switch which is closed or opened in dependence on receiving an activation signal (e.g. indicating a puff on the aerosol provision device 100). Hence power can only be supplied to the aerosol generator 230 if the safety element/switch 402 is in the closed state, and the control circuitry 250 has received an activation signal and thereby closed a switch of the control circuitry 250 providing an electrical path between the aerosol generator 230 and the power supply 240.

FIG. 7 is an example of the sensor element 400 being configured to directly control the switch 402. That is, the state of the sensor element 400 directly influences the state of the switch 402, and thus the state of the safety element. Although FIG. 7 shows the switch integrated with, and thus forming, the sensor element 400, it should be appreciated that the sensor element 400 and switch 402 may be separate and electrically coupled together to form the safety element. For example, in the arrangement shown in FIG. 7, the sensor element 400 may be used to control the switching state of the switch. For instance, if the switch 402 is a transistor (such as a FET), the sensor element 400 may be coupled to the gate of the transistor and based on the detection state of the sensor element 400, cause the transistor to be open or closed based on the output signal (detection state) of the sensor element 400.

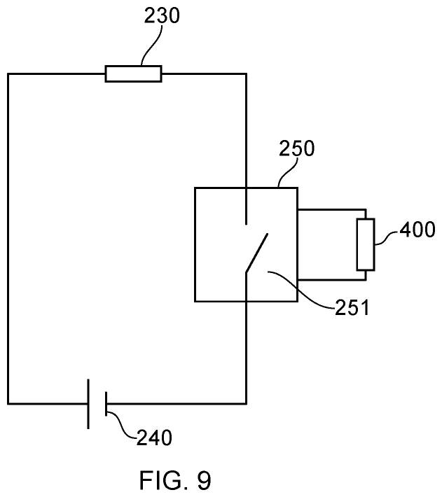

In examples where the safety element comprises a switch, ‘actuation’ of the safety element will therefore be taken to mean the changing of a switch state so as to provide a path by which current can flow through the switch. This path may comprise portions of the control circuitry 250. For instance, the sensor element 400 comprising the switch (i.e. the safety element) may be comprised in a chip embodying the control circuitry 250. The properties of the emitting element and sensor element, and their spatial arrangement relative to one another (for instance, the distance between them and their orientation) are selected such that when the cartridge and the control body are in the engaged state, the detection state of the switch corresponds to a closed-circuit state of the switch. Closing of the switch comprises actuating the safety element. In many instances, the location and orientation of the sensor element on or in the interface portion of the first one of the control body and the cartridge and the location and orientation of the emitting element on or in the interface portion of the second one of the control body and cartridge are selected such that the orientation and intensity of the signal or field emitted by the emitting element and the proximity of the emitting element relative to the sensor element location and orientation cause the detection state of the sensor element to be maximized when the cartridge and control body are fully engaged (e.g. because the distance between the sensor element and emitting element is minimized). In practice, the properties of the emitting element and sensor element, and their locations and orientations, can be configured to allow for some degree of tolerance in detection state and/or signal-/field-emitting characteristics and/or alignment of the sensor and emitting element when the cartridge and control body are engaged. In some instances, this may entail configuring the sensor element and emitting element properties and spatial locations such that as the cartridge and the control body are brought into proximity towards their engaged state, the safety element is actuated prior to full engagement of the cartridge and control body being reached. For example, FIG. 8 schematically shows an example relationship between the detection state S of an example sensor element (shown on the y-axis of the graph) and the distance d between the sensor element and the emitting element (shown on the x-axis). It should be appreciated that the detection state S as a function of distance shown in FIG. 8 is purely an example only and the actual relationship may vary depending on the nature of the emitting element 410 and the sensor element 400. As shown in FIG. 8, the detection state S is at a maximum at a minimum distance d1 between the emitting element and the sensor element, corresponding to the cartridge and control body being fully engaged. The threshold Tₛ of detection state at which the sensor is configured to switch from the open state to the closed state may be set to correspond to the value of S in the fully engaged state, when the distance is d1 (i.e. setting the threshold to Tₛ=T_{s,1}). However, setting Tₛ to a value of T_{s,2} may ensure that the switch closes at a distance d2, which is larger than the distance d1, providing a degree of tolerance and ensuring the switch does not fail to close even when the cartridge and control body are engaged. A suitable configuration of sensor element, emitting element and their locations, and a suitable value of the threshold Tₛ can be established empirically through, for example, experimentation, can be established through mathematical modelling.

As described, in other examples of the present disclosure, the sensor element 400 is not disposed in an electrical path used to supply current to the aerosol generator, but is connected to control circuitry 250 which is configured to determine whether to actuate the safety element based on measuring, or otherwise detecting, the detection state of the sensor element 400. This is an example of the sensor element 400 being configured to indirectly control the switch. That is, the state of the sensor element 400 indirectly influences the state of the switch. FIG. 9 shows a schematic example of such an arrangement, in which the sensor element 400 is connected to the control circuitry 250. The control circuitry includes a switch 251. The switch 251 may be broadly similar to switch 402. Together the switch 251 and sensor element 400 form the safety element. Again, while FIG. 9 shows the switch 251 integrated with the control circuitry 250, the switch 251 may be separate from and electrically connected to the control circuitry 250. A power supply 240 and aerosol generator 230 are further connected to the control circuitry 250. In these embodiments, the actuation state of the safety element 251 depends on a determination made by the control circuitry 250 on the basis of the measured detection state of the sensor element 400. The detection state of the sensor element may take effectively binary values (for instance, open or closed, as in a switch as set out above), but may also take a continuous range of values depending on the characteristics of a field or signal in the vicinity of the sensor element. Thus, for instance, in a non-limiting example where the sensor element comprises a photodiode, the detection state of the sensor element, as measured, for instance, by the degree of current passing through the photodiode at a given potential difference applied by control circuitry (in photoconductive mode) or by the potential difference measured across the photodiode (in photovoltaic mode), may take a range of values depending on the intensity and/or wavelength of incident light received by the sensor element. The measurement of the sensor element detection state may comprise measuring either an absolute value or change in the value of a parameter associated with the sensor element, such as, for example a resistance, conductivity, inductance, impedance, reactance, or capacitance parameter. What may be considered significant is that the parameter associated with the sensor element and used to determine the detection state is configured to vary in dependence on a characteristic of an incident field or signal emitted by the emitting element. The detection state of the sensor element can be measured by the control circuitry according to any suitable approach known to the skilled person, and, as set out further below, may be measured on a continuous, periodic or ad hoc basis.

The determination by the control circuitry of whether or not to actuate the safety element on the basis of the detection state of the sensor element can be based on comparing the measured detection state of the sensor element to one or more predefined detection thresholds. By establishing (for example, through experimentation or modelling) a value or range of values of measured detection state which correspond with a condition whereby the control body and cartridge are fully engaged, one or more predetermined thresholds can be set to define a corresponding range of detection state in which the safety element will be actuated. The control circuitry is configured to determine the measured detection state of the sensor element and to actuate the safety element if the detection state is within the predefined range. It will be appreciated that the measured detection state may be compared to a single threshold, or more than one threshold (for example defining a range), and any suitable comparison of the measured detection state and the one or more thresholds may be used to determine whether the safety element should be actuated (i.e. the detection state may be required to be above or below a threshold). Other characteristics of the detection state other than magnitude may be determined by the control circuitry and used to determine whether to actuate the safety element (for instance, the phase, periodicity, or duration of the detection state, or parameters derived from signal processing approaches applied to a time-resolved measurement of the detection state).

Actuation of the safety element by the control circuitry can comprise the setting of any state or variable associated with the control circuitry which prevents power being supplied to the aerosol generator. This may comprise setting a flag in a software or firmware routine associated with the operation of the control circuitry, and/or a state in a hardware latch comprised in the control circuitry, and/or a value in a register comprised in control circuitry, wherein the control circuitry is configured not to supply current to the aerosol generator unless the flag, state or value takes a certain value or is within a certain range which is predetermined to indicate the safety element is in an actuated state. It will be appreciated that the safety element can comprise any hardware or software configuration of the control circuitry which is operable to be placed in either of two states, wherein the state determines whether or not the control circuitry supplies current to be supplied to the atomizer upon receipt of an activation signal. Actuation of the safety element may comprise the control circuitry changing the state of a switch in an electrical path used to provide current to the aerosol generator such that the path comprises a closed circuit.

In some examples of the present disclosure, setting of the actuation state of the safety element is based on a continuous monitoring process. For instance, where the control circuitry is configured to measure the detection state of the sensor element, the control circuitry may be configured to make such measurements on a continuous or semi-continuous basis (e.g. according to predetermined time intervals). In other embodiments, the actuation state is determined on an ‘ad hoc’ basis as part of a control sequence according to which the device is configured to supply power to the aerosol generator in response to receiving an activation signal from an airflow sensor or other user input device (e.g. a button). In these instances, the determination of the detection state of the sensor element and the setting of the actuation state of the safety element in dependence on the detection state may be considered to comprise a check conducted by the control circuitry prior to supplying power to the aerosol generator in accordance with receiving an activation signal. Such a check may also be performed when the device is first switched on.

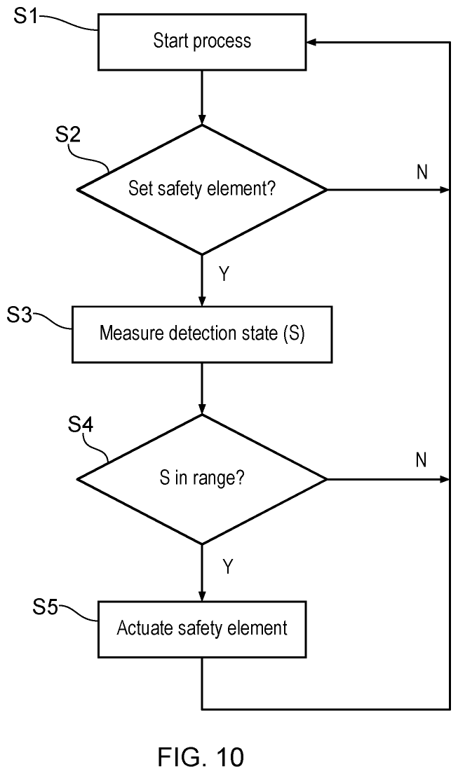

FIG. 10 shows a schematic example of a control algorithm which may be implemented by control circuitry 250. According to S1, the procedure is started. This may occur whenever the device/system is powered on, e.g., via a manual-actuatable switch on the control body 200. According to S2, the control circuitry 250 determines whether to set or otherwise determine an appropriate actuation state for the safety element. This determination may be in response to the device being switched on, a predetermined timing schedule, determining a change in the detection state of the safety element, receiving an activation signal, or any other suitable trigger. If during S2 it is decided that the actuation state for the safety element should be set or otherwise determined, then according to S3, the control circuitry 250 measures the detection state of the sensor element 400. This may comprise measuring an absolute value of the detection state or a change in the detection state relative to one or more previously measured values. The measurement of detection state may comprise a time-resolved measurement. In S4, the control circuitry 250 then determines whether the detection state of the sensor element is within a predetermined range which indicates the cartridge and the control body are engaged. This may comprise comparing the measured detection state to one or more thresholds, or otherwise analyzing the measured detection state (for example, conducting analysis of a time resolved measurement) and determining the measured detection state meets a predefined criterion (for instance, in terms of a characteristic such as rate of change or phase of the detection state). If the control circuitry determines the measured detection state meets the predetermined criteria/criterion, then according to S5 the safety element is actuated according to any of the approaches set out further herein. The process may continuously loop round, and in this regard the determination of the actuation state of the safety element may be considered to be continuous.

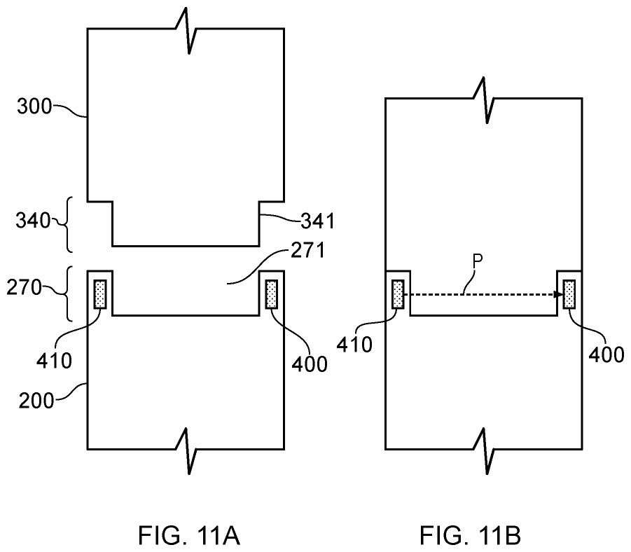

In some examples of the present disclosure, the emitting element 410 and the sensor element 400 are not comprised in separate ones of the cartridge and control body, but rather a first one of the cartridge or control body comprising the sensor element 400 further comprises an emitting element configured to emit a first field or signal, and the detection state of the sensor element is configured to vary in dependence on a characteristic of a second field or signal associated with the first field or signal, wherein an association between the first field or signal and the second field or signal depends on the characteristic of the second one of the cartridge and the control body. In many respects, such examples may be configured in the same manner as the first embodiment, for instance in terms of how the safety element is actuated on the basis of the detection state of the sensor element. However, there may be some modifications to the way in which a characteristic of the second one of the cartridge and control body influences the detection state of the sensor element when the control body and cartridge are engaged. FIGS. 11A and 11B, which will be understood from FIGS. 4A and 4B, show schematically an interface portion 270 of the control body 200, which in this example comprises a recess 271 formed in the control body, with a sensor element 400 and an emitting element 410 associated the interface portion 270 (for instance disposed on, in, or internal to a housing comprising the interface portion. FIG. 11A shows schematically a scenario in which an interface portion 340 of the cartridge 300 is not engaged with the control body, and FIG. 11B shows a scenario in which the interface portion 340 (here comprising a boss 341 configured to be received into the recess 271) has been engaged with the interface portion 270 to couple the cartridge and control body, such that a portion of the interface portion 340 intersects with a path P between the sensor element 400 and emitting element 410. It will be appreciated that the sensor element 400 and emitting element 410 may be comprised in the cartridge 300, and communicate with the control circuitry via, for instance, a wirelessly transmitted signal communicated over a wireless interface (for example, a Bluetooth interface), or a wired communication established by connecting respective signal lines in the cartridge and control body. The cartridge may comprise a power supply to power the sensor element 400 and/or emitting element 410, and any associate control circuitry.

In general, the second field or signal will comprise a transformed or modified version of the first field or signal, wherein the first field or signal emitted by the emitting element is transformed or modified by a portion of the second one of the control cartridge and control body via a process of reflection, attenuation, absorption, distortion, refraction, scattering, or absorption and re-emittance when the cartridge is engaged with the control body. As set out further herein, the sensor element may be configured with a detection state that is sensitive to the second field or signal. The detection state of the sensor element may additionally or alternatively be sensitive to the first field or signal. The emitting element, the sensor element, and the characteristic of the second one of the cartridge and the control body are configured such that a characteristic of the second field or signal to which the detection state of the sensor element is sensitive will be different at the sensor element location depending on whether the cartridge and control body are engaged or not engaged.

The procedure used to set the actuation state of the safety element on the basis of the detection state of the sensor element can follow any of the approaches set out further herein. Thus the safety element may comprise a sensor element acting as a switch, disposed in an electrical path used to supply current from the power supply to the aerosol generator, as shown schematically in FIG. 7. Alternatively, the actuation of the safety element may be carried out by the control circuitry, based on the measured detection state of the sensor element, with the sensor element, control circuitry, power supply and aerosol generator arranged, for example, as shown schematically in FIG. 9. The determination and/or setting of the actuation state of the safety element will generally comprise emitting the first field or signal during the period in which the actuation state of the safety element is being set/determined. For example, in some embodiments, the emitting element is controlled by control circuitry, and the routine used by the control circuitry to measure the detection state of the sensor element in order to determine whether to actuate the safety element includes the step of activating the emitting element to produce a first field or signal with predefined characteristics prior to making the measurement. In other embodiments, the emitting element may be configured to permanently produce the first field or signal (for instance the emitting element may be a passive emitter such as a magnet), or to produce the first field or signal during any period when the aerosol provision system is switched on. In embodiments whereby the safety element comprises a sensor element configured as a switch in the power supply circuit as shown schematically in FIG. 7, the emitting element may be configured to emit the field or signal during any period in which the control circuitry 250 determines the aerosol generator should be activated (for example, for the duration of a period in which an activation signal from a puff sensor or user input device is being received by the control circuitry 250).

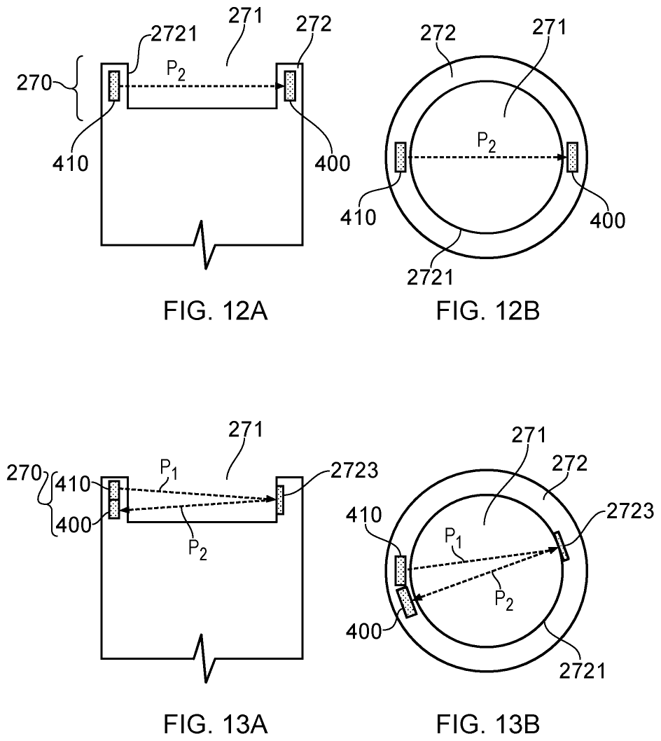

In some examples of the present disclosure, the emitting element and sensor element are arranged such that the first field or signal emitted by the emitting element is transformed or modified to produce the second field or signal via transmission of the first field or signal through a portion of the second one of the cartridge and control body. In a first set of examples, the emitting element and sensor are arranged such that the first field or signal is receivable by the sensor element when the cartridge and control body are not engaged. For example, the sensor and emitting elements may face one another across a space (e.g. a cavity or slot) into which a portion of the second one of the cartridge and control body is received when the cartridge and control body are engaged. An example of this arrangement is shown schematically in FIGS. 12A and 12B, which respectively show side and top views of an interface portion of a first one of a cartridge and control body, comprising a recess or slot 271, and in which a sensor element 400 and emitting element 410 are disposed at opposing positions of a housing 272, such that a path P exists between the sensor element-400 and emitting element 410. Alternatively the emitting element 410 and sensor element 400 may not face one another (i.e. in the sense that the first field or signal is oriented directly towards the sensor element 400 by the emitting element 410), but are arranged such that the first field or signal is directed to the sensor element 400 via reflection from one or more surfaces (for instance external surface(s) 2721 of the housing 272 which face the slot or recess 271). For instance, the emitting element 410 and sensor element 400 may be disposed at proximate locations, and the first field or signal can be emitted to traverse the recess or slot 271, being reflected from a reflective wall portion 2723 back towards the sensor. An example of this arrangement is shown schematically in FIGS. 13A and 13B which respectively show side and top views of a space comprising a recess or slot, and in which a sensor element 400 and emitting element 410 are disposed facing a reflective portion 2723 of the wall 2721 of the slot or recess 271 which causes the first field or signal emitted by emitting element 410 along a path P1 to be reflected back towards sensor element 400 along a path P2. The paths P1 and P2 may or may not overlap.

According to some examples of the present disclosure, when the control body and cartridge are not engaged (i.e. in an unengaged state), the first field or signal is emitted by the emitting element in such a direction that at least part of the signal or field is received by the sensor element, causing the sensor element to have a first detection state or range of detection states characteristic of the unengaged state. In general, the first field or signal will be emitted by the emitting element according to a set of predefined emittance parameters which will usually be constant, so as to produce a first field or signal with substantially constant characteristics (e.g. in terms of intensity, periodicity, orientation, wavelength, etc.). In some examples, the detection state of the sensor element is sensitive to one or more characteristics of the first field or signal, and providing a first field or signal with constant characteristics from the emitting element results in the detection state of the sensor taking a first value or range of values which is substantially constant in scenarios where the cartridge and control body are not engaged. In other instances, the sensor element is not sensitive to the first field or signal, and the detection state of the sensor will be constant when the control body and cartridge are not engaged, regardless of the characteristics of the emitted field or signal. As described further herein, the interface portion of the first one of the control body may need to be configured (e.g. in terms of material selection, shape and dimensions) such that the first and/or second field or signal can be received by the sensor element. As set out further herein, this may comprise disposing sensor element and/or emitting element on the surface of, embedded in, or disposed internal to a housing comprising the interface portion of the first one of the control body and cartridge as shown in FIGS. 5A, 5B and 5C, and/or ensuring the materials in the path between the emitting element and the sensor element are transparent to the first and/or second field or signal.

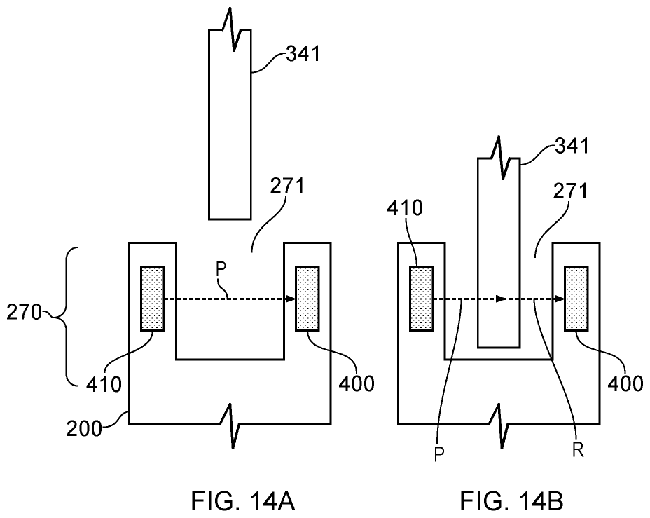

The interface portion of the second one of the cartridge and control body is configured such that a portion of the second one of the cartridge and control body at least partially intersects a signal path P (which may comprise path a plurality of path portions P1, P2, . . . , Pn) between the emitting element and the sensor element when the cartridge and control body are brought into engagement. For example, the portion configured to intersect the path P may comprise a boss or tab shaped to be inserted into a recess or slot 271 associated with the interface portion of the first one of the cartridge and control body. When the control body and cartridge are brought into engagement, the intersection of the portion of the second one of the cartridge and control body with the signal path P between the emitting element and the sensor element causes the first field or signal to be transformed or modified, producing a second field or signal, generally comprising an attenuated and/or scattered version of the first field or signal. FIGS. 14A and 14B show schematically an example in which a sensor element 400 and emitting element 410 are configured to face one another across a recess 271 comprising an interface portion of a control body 200, as set out further herein. FIG. 4A shows a scenario where the cartridge and control body are not engaged, and a first field or signal emitted by the emitting element 410 is received by the sensor element 400 along a path P. FIG. 14B shows a scenario where the cartridge 200 and a control body 300 are engaged, such that a portion 341 of the interface portion of the second one of the cartridge and control body is received into the recess 271. Interaction of the portion 341 with the first field or signal causes a second field or signal to be received by the sensor element 400 along a path R, which may partially or fully overlap with path P. The second field or signal may be reflected from a portion of the internal surface of the recess or slot 271 (such as a reflective portion 2723 as shown schematically in FIGS. 13A and 13B) and interact again with the portion 341 of the second one of the cartridge and control body before being received by the sensor element 400. The transformation or modification of the first field or signal by the portion 341 of the second one of the cartridge and control body to produce the second field or signal may be via any appropriate process, such as reflection, attenuation, absorption, distortion, refraction, scattering, or absorption and re-emittance (e.g. photoexcitation). The sensor element 400 is configured such that its detection state or range of detection states in the presence of the second field or signal is different to the detection state in the presence of the first field or signal. The material properties and/or structure of the portion 341 of the second one of the cartridge and control body configured to interact with the first field or signal are selected to produce a second field or signal which causes the detection state of the sensor element 400 to be different to its detection state in the presence of the first field or signal. In some instances the second field or signal will represent a complete attenuation of the first field or signal, such that no field or signal associated with the first field or signal is received at the sensor element 400 when the cartridge 300 and control body 200 are engaged (i.e. the second field or signal is a ‘null’ field or signal). In these examples, the sensor element 400 is configured with a detection state which is sensitive to the first field or signal. The detection state will have a baseline value or range of values when the first field or signal is emitted by the emitting element and the cartridge and control body are not engaged (i.e. when the sensor element is receiving the unattenuated first field or signal). Engaging the cartridge 300 and control body 200 causes the portion 341 of the second one of the cartridge and control body to interact with the first field or signal, causing the second field or signal to be received by the sensor element 400, and thereby causing the detection state of the sensor element to shift away from the baseline detection state (for instance, because the second field or signal is a partially or fully attenuated version of the first field or signal). According to the approaches set out in relation to the first embodiment, the safety element can thereby be actuated on the basis of whether or not a characteristic of the detection state of the sensor element meets a predefined criterion (e.g. being within a predefined range which excludes the baseline value(s) but includes the detection state(s) associated with the second field or signal being received by the sensor element 400).

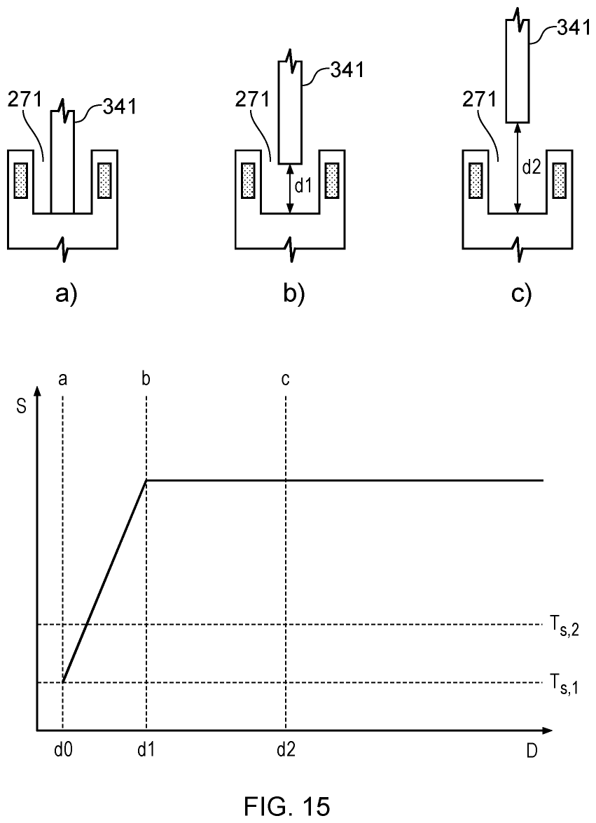

FIG. 15 shows schematically a relationship between a detection state S of the sensor element 400, and a distance D indicating the degree of engagement of the cartridge and control body (for example, the distance between the base of an interface portion 341 comprising a boss and the base of a recess 271 comprised in an interface portion 270 into which the boss is received). The distance d0 indicates the fully engaged state, where the distance between the interface portions of the cartridge and control body is minimized. This is illustrated by the schematic shown at (a), in which the portion 341 contacts the base of the recess 271. Distance d1 indicates a distance at which the presence of the portion of the second one of the cartridge and control body within the path between the sensor element and emitting element is just beginning to cause the second field or signal to be produced (e.g. by attenuating the first field or signal emitted by the emitting element). This is illustrated by the schematic shown at (b). Distance d2 indicates a distance at which the second one of the cartridge and control body is not influencing the first field or signal to cause the second field or signal to be produced. This is illustrated by the schematic shown at (c). A threshold value of S used to determine whether the safety element should be actuated may be set as T_{s,1}, to correspond to full engagement of the cartridge and control body, or at a value T_{s,2} to cause the safety element to be actuated prior to full engagement (i.e. between the scenarios illustrated by (a) and (b)), providing a degree of tolerance for manufacturing or measurement variation.

In some examples of the present disclosure, the detection state of the sensor element is not sensitive to the first field or signal, but is only sensitive to the second field or signal produced by interaction of a portion of the second one of the control body and the cartridge with the first field or signal. The characteristic of the second one of the cartridge and control body which determines the association between the first field or signal and the second field or signal may comprise a capacity to be excited by the first field or signal so as to produce the second field or signal. For instance, the portion of the second one of the cartridge and control body may comprise a luminescent material, the first field or signal may be an electromagnetic field or signal configured to cause excitation of the luminescent material, and the second field or signal may comprise an electromagnetic field or signal produced by photoexcitation of the luminescent material and having different characteristics to those of the first field or signal. If the sensor element is only sensitive to (or is more strongly sensitive to) the characteristics of the second field or signal as compared to those of the first field or signal, the detection state of the sensor element will be different depending on whether or not the cartridge and control body are engaged. According to the approaches set out further herein, the safety element can thereby be actuated on the basis of the detection state.

It will be appreciated many sensor element and emitter element modalities may be used in the examples set out herein. In some examples the characteristic associated with the second one of the cartridge and the control body comprises an optical characteristic, and the first field or signal emitted by the emitting element comprises an optical signal. In some examples the characteristic associated with the second one of the cartridge and the control body comprises an acoustical characteristic, and the first field or signal emitted by the emitting element comprises an acoustical signal. In some examples, the emitting element comprises a first electrode configured to generate a first field comprising an electric field, and the sensor element is configured with a detection state which varies in dependence on a degree of capacitive coupling between the first electrode and a second electrode. The combination of first and second electrodes may comprise the sensor element, the detection state of which comprises a degree of capacitive coupling between the first and second electrodes under predefined drive conditions, controlled by the control circuitry. The presence of the portion 341 of the second one of the cartridge and the control body within the electric field between the electrodes when the cartridge and control body are engaged causes the first field or signal to be modified to produce a second field or signal (for example, as a function of the dielectric properties of the portion 341 of the second one of the cartridge and the control body). The change in the electric field causes the detection state of the sensor element to change. According to the approaches set out further herein, the safety element can thereby be actuated on the basis of the detection state. In other examples of the second embodiment, the characteristic associated with the second one of the cartridge and the control body comprises an RFID tag disposed in or on the second one of the cartridge and the control body, the first field or signal comprises an electromagnetic signal receivable by the RFID tag, and the second field or signal comprises a signal emitted by the RFID tag in response to receiving the first signal. The sensor is configured with a detection state that is sensitive to the second field or signal emitted by the RFID tag, and according to the approaches set out further herein, the safety element can thereby be actuated on the basis of the detection state.

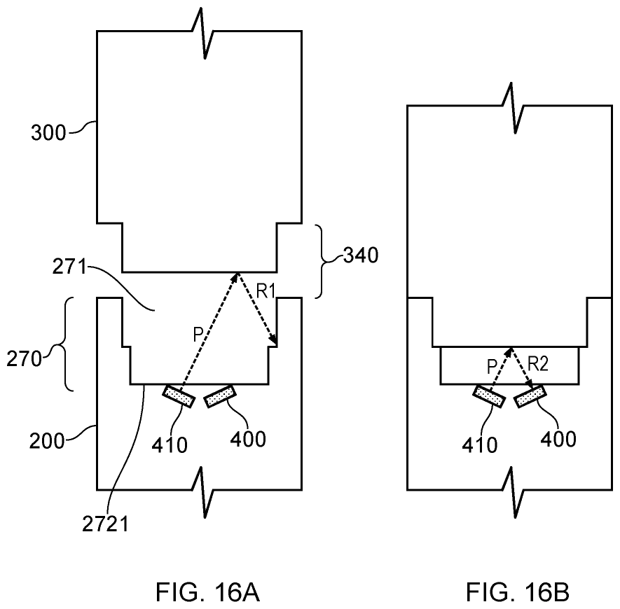

According to some examples of the present disclosure, the emitting element and sensor element are arranged such that the first field or signal emitted by the emitting element is transformed or modified to produce the second field or signal via reflection or absorption and re-emittance from a portion of the second one of the cartridge and control body which is configured to receive at least a portion of the first field or signal when the cartridge and control body is engaged. These examples may be configured in largely the same way as the other examples of the second embodiment set out above. Accordingly, the sensor element 400 and emitting element 410 will in general be disposed proximate to one another in, on or internal to a portion of a housing comprising the interface portion of the first one of the second field or signal. A difference to other examples described herein is that the emitting element 410 will in general not be configured (e.g. positioned and oriented) such that the first field or signal is directed towards the sensor element 400 (either directly across an air gap, or via one or more reflections from, for instance, internal walls of a recess or cavity 271). An example of this arrangement is shown schematically in FIG. 16A, which shows a section view through part of the interface portion 270 of the first one of the cartridge and control body, which as in other examples can comprise a recess 271 (though this is not essential). FIG. 16A shows a scenario whereby the cartridge and control body are not engaged. When the control body and cartridge are engaged, an interface portion 340 of the second one of the control body and the cartridge is received into the recess, as shown schematically in FIG. 16B. A sensor element 400 and emitting element 410 are disposed at suitable locations, for instance, on an external surface 2721 of the interface portion 270, embedded in a housing 272 comprising the interface portion 270, or disposed internal to such a housing. Depending on the nature of the first field or signal and the second field or signal, a housing comprising the interface portion may need to be shaped and/or made of suitable material (e.g. a material partially or fully transparent to the first and/or second field or signal) such that the first field or signal can be emitted from the interface portion by the emitting element, and a second field or signal can be received by the sensor element. The emitting element and sensor element are arranged such that the second field or signal is most strongly received by the sensor element when the cartridge and control body are fully engaged. FIG. 16A shows a first field or signal emitted by the emitting element along path P being reflected/re-emitted from the interface portion of the second one or the cartridge and control body along a path R1, such that the second field or signal is predominantly directed away from the sensor element 230. FIG. 16B shows a scenario when the cartridge 300 and control body 200 are engaged, whereby due to the configuration of the interface portion of the second one of the cartridge and control body, and the orientations of the sensor element 400 and emitting element 410, the first field or signal is reflected or re-emitted along a path R2, causing the second field or signal to be directed towards the sensor element. In many instances, the emitting element will be configured to emit the field or signal in a direction substantially normal to the surface of the interface portion at the location where the emitting element is situated. The sensor element may be at a position on the interface portion which is proximate to or surrounds the emitting element, and be configured such that the detection state is most strongly sensitive to a second field or signal received in a direction substantially normal to the surface of the interface portion at the location where the emitting element is located. However these configurations are examples, and any suitable configuration can be used. What is significant is that when the cartridge 300 and control body 200 are engaged, part of the interface portion 340 of the second one of the cartridge and control body will be brought into proximity to the sensor element 400 and emitting element 410 such that a first field or signal emitted by the emitting element is reflected, absorbed and re-emitted, or guided through a portion of the second one of the cartridge and control body so as to be received by the sensor element 400. The properties of the interface portion 340 of the second one of the cartridge and control body are selected such that the first field or signal emitted by the emitting element 410 is thereby modified or transformed by the interface portion 340 of the second one of the cartridge and control body, producing a second field or signal which to which the detection state of the sensor element 400 is sensitive. Thus when the cartridge and control body are engaged, the first field or signal may be reflected, or reabsorbed and re-emitted by part of the interface portion 340 of the second one of the cartridge 300 and control body 200 in the vicinity of the emitting element and sensor element 400. For predefined characteristics of the first field or signal, the characteristics of the second field or signal at the sensor element will be dependent on the degree of engagement of the cartridge and control body, varying for instance in dependence on the proximity of the cartridge and control body and/or the alignment of the cartridge and control body. The actuation state of the safety element can therefore be set based on the detection state of the sensor element using any of the approaches set out further herein.

In some examples of the second embodiments, the interface portion 340 of the second one of the control body and cartridge comprises a waveguide 341 (such as a fiber-optic element or acoustic tube) configured to receive the first field or signal from the emitting element and direct the second field or signal towards the emitting element when the cartridge and control body are engaged. In other examples, the sensor element comprises a capacitive sensor, and the emitting element comprises a first electrode configured to generate an electric field, wherein the sensor element is configured with a detection state which varies in dependence on a degree of capacitive coupling between the first electrode and a second electrode associated with either the control body or the cartridge. The sensor may therefore comprise the first electrode and a reference electrode, forming a proximity sensor, arranged with a detection state which changes as a function of the proximity of the interface portion of the second one of the cartridge and the control body to the sensor. The detection state will generally comprise the mutual capacitance of the capacitor. Alternatively, the sensor element and emitting element may comprise a single electrode configured as a self-capacitance sensor, wherein the self capacitance varies as a function of the proximity of the interface portion of the second one of the cartridge and the control body.

In some examples of the present disclosure, the characteristic associated with the second one of the cartridge and the control body comprises a manner in which a portion of the second one of the cartridge and the control body interacts with an ambient field or signal which is receivable by the sensor element when the cartridge is not engaged with the control body. In many respects, these examples may be configured in accordance with the examples already described, with the difference that the emitting element which emits the field or signal to which the detection state of the sensor element is sensitive is not associated with the second one of the cartridge and control body but is an ambient source. In general, the sensor element is arranged relative to the interface portion of the first one of the cartridge and control body such that an ambient field or signal can be received when the cartridge and the control body are not engaged, causing the sensor element to have a first range of detection states depending on the characteristics of the ambient signal or field and the orientation and location of the first one of the cartridge and control body. The aerosol provision system 100 is further configured such that when the cartridge and the control body are engaged, a portion of the interface portion of the second one of the cartridge and the control body occludes the sensor element, preventing the ambient field or signal being received. Thus when the cartridge and the control body are engaged, the detection state will be different to a usual range of states when the cartridge and the control body are not engaged, and this difference can be used to determine thresholds to use for determining whether to actuate the safety element, in accordance with the approaches described further herein. In one example, the ambient signal comprises an optical signal (for instance from the sun, and or indoor lighting), and the sensor element comprises a photosensor as described further herein. When the cartridge and the control body are engaged, a portion of the interface portion of the second one of the cartridge and the control body occludes the photosensor, preventing the optical signal being received. The safety element is configured only to be actuated if the detection state is in a condition indicating no optical signal is reaching the sensor element.

Thus, there has been described an aerosol provision system comprising a control body and a cartridge configured to engage with the control body, wherein the control body comprises an aerosol generator configured to generate aerosol from aerosol-generating material, the aerosol provision system further comprising a aerosol-generating material storage area comprised in the cartridge configured to hold a supply of aerosol-generating material to be aerosolized by the aerosol generator, circuitry configured to control a supply of energy from a power supply to the aerosol generator, and a safety element configured to actuate when the cartridge is engaged with the control body, wherein the circuitry is configured to prevent the supply of energy to the aerosol generator unless the safety element is actuated.

While the above described embodiments have in some respects focused on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, the entirety of this disclosure shows by way of illustration various embodiments in which that which is claimed may be practiced and provide for superior aerosol provision systems and replaceable cartridge parts that comprise a primary air channel for providing fluid communication between an aerosol source for generating aerosol from a source material for user inhalation and a mouthpiece end, and a secondary air channel for providing fluid communication between a sensor element and mouthpiece end. The advantages and features of the disclosure are of a representative sample of embodiments only, and are not exhaustive and/or exclusive. They are presented only to assist in understanding and to teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision system comprising:
a control body comprising an aerosol generator configured to generate aerosol from aerosol-generating material;
a consumable configured to engage with the control body;
an aerosol-generating material storage area comprised in the consumable and configured to hold a supply of the aerosol-generating material to be aerosolized by the aerosol generator;
circuitry configured to control a supply of energy from a power supply to the aerosol generator; and
a safety element configured to actuate when the consumable is engaged with the control body,
wherein the circuitry is configured to prevent the supply of energy to the aerosol generator unless the safety element is actuated.

2. The aerosol provision system of claim 1, wherein the safety element comprises a sensor associated with a first one of the consumable or the control body and is configured with a detection state which varies in dependence on a characteristic of a second one of the consumable or the control body, such that a presence of the second one of the consumable or control body when the consumable is engaged with the control body influences the detection state of the sensor, and wherein an actuation state of the safety element depends on the detection state of the sensor.

3. The aerosol provision system of claim 2, wherein the characteristic associated with the second one of the consumable or the control body comprises a characteristic which interacts with an ambient optical signal, an ambient acoustical signal, or an ambient magnetic field which is receivable by the sensor when the consumable is not engaged with the control body.

4. The aerosol provision system of claim 2, wherein the characteristic associated with the second one of the consumable or the control body comprises a signal or a field emitted by an emitting element associated with the second one of the consumable or the control body, wherein the detection state of the sensor varies in dependence on a characteristic of the signal or the field.

5. The aerosol provision system of claim 4, wherein the signal or the field emitted by the emitting element comprises a magnetic field.

6. The aerosol provision system of claim 3, wherein the first one of the consumable or the control body comprises an emitting element configured to emit a first field or a first signal, and the detection state of the sensor is configured to vary in dependence on a characteristic of a second field or a second signal associated with the first field or the first signal, wherein an association between the first field or the first signal and the second field or the second signal depends on the characteristic of the second one of the consumable or the control body.

7. The aerosol provision system of claim 6, wherein the second field or the second signal comprises a transformed version or a modified version of the first field or the first signal, wherein the first field or the first signal is transformed or modified by a portion of the second one of the control consumable or the control body via a process of reflection, attenuation, absorption, distortion, refraction, scattering, or absorption and re-emittance when the consumable is engaged with the control body.

8. The aerosol provision system of claim 6, wherein the characteristic associated with the second one of the consumable or the control body comprises a magnetic characteristic, and the first field or the first signal comprises a magnetic field.

9. The aerosol provision system of claim 6, wherein the characteristic associated with the second one of the consumable or the control body comprises an RFID tag, the first field or the first signal comprises an electromagnetic signal receivable by the RFID tag, and the second field or the second signal comprises a signal emitted by the RFID tag in response to receiving the first signal.

10. The aerosol provision system of claim 7, wherein the characteristic associated with the second one of the consumable or the control body comprises an optical characteristic, and the first field or the first signal comprises an optical signal.

11. The aerosol provision system of claim 7, wherein the characteristic associated with the second one of the consumable or the control body comprises an acoustical characteristic, and the first field or the first signal comprises an acoustical signal.

12. The aerosol provision system of claim 7, wherein the emitting element comprises a first electrode configured to generate an electric field, wherein the sensor is configured with a detection state which varies in dependence on a degree of capacitive coupling between the first electrode and a second electrode associated with either the control body or the consumable.

13. The aerosol provision system of claim 12, wherein the second electrode is associated with the first one of the control body or the consumable.

14. The aerosol provision system of claim 12, wherein the second electrode is associated with the second one of the control body or the consumable.

15. The aerosol provision system of claim 6, wherein the emitting element and the sensor are arranged such that the first field or the first signal is transformed or modified to produce the second field or the second signal via transmission through the portion of the second one of the consumable or the control body.

16. The aerosol provision system of claim 6, wherein the emitting element and the sensor are arranged such that the first field or the first signal is transformed or modified to produce the second field or the second signal via reflection from the portion of the second one of the consumable or the control body.

17. The aerosol provision system of claim 2, wherein the safety element is configured to be actuated if the detection state of the sensor is within a predefined range, and wherein the predefined range is set such that the detection state of the sensor is only within the predefined range when the consumable and the control body are engaged.

18. The aerosol provision system of claim 2, wherein the one of the consumable or the control body comprising the sensor comprises a housing having an outer surface and an inner surface, and wherein the sensor is fully or partially embedded between the inner surface and the outer surface of the housing.

19. The aerosol provision system of claim 2, wherein the one of the consumable or the control body with which the sensor is associated comprises a housing having an outer surface and an inner surface, and wherein the sensor is disposed internally to the inner surface of the housing.

20. The aerosol provision system of claim 2, wherein the sensor comprises a switch disposed in an electrical path used to supply current from the power supply to the aerosol generator, and wherein the switch only permits current to flow to the aerosol generator if the detection state of the sensor is within the predefined range.

21. The aerosol provision system of claim 2, wherein the sensor is connected to control circuitry configured to measure the detection state of the sensor, and wherein the control circuitry only permits current to flow to the aerosol generator if the measured detection state is within the predefined range.

22. The aerosol provision system of claim 2, wherein the control body comprises the sensor.

23. The aerosol provision system of claim 2, wherein the consumable comprises the sensor.

24. The aerosol provision system of claim 1, wherein the consumable comprises the aerosol-generating material storage area for holding the supply of the aerosol-generating material.

25. The aerosol provision system of claim 24, wherein the aerosol provision system comprises an aerosol-generating material transfer component configured to transport the aerosol-generating material from the aerosol-generating material storage area to the control body for aerosolization by the aerosol generator.

26. The aerosol provision system of claim 1, wherein the aerosol generator comprises a heating element.

27. The aerosol provision system of claim 26, wherein the aerosol provision system is configured to generate the aerosol via heat from the aerosol generator being transported from the control body to the consumable to heat a portion of the aerosol-generating material contained in the consumable.

28. The aerosol provision system of claim 2, wherein the circuitry comprising the safety element is entirely comprised in the first one of the consumable or the control body.

29. The aerosol provision system of claim 1, wherein at least a portion of the aerosol generator is exposed when the consumable is disengaged from the control body.

30. A consumable for an aerosol provision system comprising the consumable and a control body configured to engage with the consumable, wherein the control body comprises an aerosol generator configured to generate aerosol from aerosol-generating material comprised in the consumable, circuitry configured to control a supply of energy from a power supply to the aerosol generator; and at least a part of a safety element, wherein the circuitry is configured to prevent the supply of energy to the aerosol generator unless the safety element is actuated, the consumable comprising:
an aerosol-generating material storage area for holding a supply of the aerosol-generating material to be aerosolized by the aerosol generator,
wherein the consumable is configured the cause the safety element to actuate when the consumable is engaged with the control body.

31. A control body for an aerosol provision system comprising the control body and a consumable configured to engage with the control body, wherein the control body comprises;
an aerosol generator configured to generate aerosol from a supply of aerosol-generating material comprised in the consumable;
circuitry configured to control a supply of energy from a power supply to the aerosol generator; and
a safety element,
wherein the circuitry is configured to prevent the supply of energy to the aerosol generator unless the safety element is actuated, and wherein the control body is configured such that the safety element is actuated when the consumable is engaged with the control body.

32. Circuitry for a control body for an aerosol provision system comprising the control body and a consumable configured to engage with the control body, wherein the control body comprises an aerosol generator configured to generate aerosol from a supply of aerosol-generating material comprised in the consumable, circuitry configured to control a supply of energy from a power supply to the aerosol generator; and a safety element, wherein the circuitry is configured to prevent the supply of energy to the aerosol generator unless the safety element is actuated, and wherein the control body is configured such that the safety element is actuated when the consumable is engaged with the control body.

33. A method of operating an aerosol provision system comprising a control body and a consumable configured to engage with the control body, wherein the control body comprises an aerosol generator configured to generate aerosol from aerosol-generating material, the aerosol provision system further comprising: a aerosol-generating material storage area for holding a supply of aerosol-generating material to be aerosolized by the aerosol generator; circuitry configured to control a supply of energy from a power supply to the aerosol generator; and a safety element configured to actuate when the consumable is engaged with the control body, wherein the method comprises:
the circuitry preventing the supply of energy to the aerosol generator unless the safety element is actuated.

34. An aerosol provision system comprising:
a control body comprising aerosol generator means configured to generate aerosol from aerosol-generating material;
a consumable configured to engage with the control body;
aerosol-generating material storage means comprised in the consumable and configured to hold a supply of the aerosol-generating material to be aerosolized by the aerosol generator means;
circuitry means configured to control a supply of energy from power supply means to the aerosol generator means; and
safety means configured to actuate when the consumable is engaged with the control body,
wherein the circuitry means is configured to prevent the supply of energy to the aerosol generator means unless the safety means is actuated.

35. A method of operating an aerosol provision system comprising a control body and a consumable configured to engage with the control body, wherein the control body comprises aerosol generator means configured to generate aerosol from aerosol-generating material, the aerosol provision system further comprising aerosol-generating material storage means for holding a supply of aerosol-generating material to be aerosolized by the aerosol generator means; circuitry means configured to control a supply of energy from power supply means to the aerosol generator means; and safety means configured to actuate when the consumable is engaged with the control body, the method comprising:
the circuitry means preventing the supply of energy to the aerosol generator means unless the safety means is actuated.
